(19) United States
(12) Patent Application Publication
(10) Pub. No.: US 2025/0019287 A1
(43) Pub. Date: Jan. 16, 2025

(54) HYBRID GLASS MANUFACTURING FURNACE WITH ELECTRIC MELTING, FOR SUPPLYING A FLOAT UNIT

(71) Applicant: SAINT-GOBAIN GLASS FRANCE, COURBEVOIE (FR)

(72) Inventors: Aurélien SAGET, COURBEVOIE (FR); Philippe DE DIANOUS, COURBEVOIE (FR); Arnaud LE VERGE, COURBEVOIE (FR); Jean-Marie COMBES, COURBEVOIE (FR)

(21) Appl. No.: 18/711,435

(22) PCT Filed: Nov. 15, 2022
(86) PCT No.: PCT/EP2022/082035

§ 371 Date: May 17, 2024

(30) Foreign Application Priority Data
Nov. 18, 2021 (EP) 21306609.5
Jun. 13, 2022 (EP) 22305857.9

(51) Int. Cl. C03B 5/03; C03B 5/185; C03B 5/193; C03B 18/00

(52) U.S. Cl. CPC C03B 5/031; C03B 5/185; C03B 5/193; C03B 18/00

(57) ABSTRACT

A hybrid glass manufacturing furnace for supplying a unit for floating the glass on a molten metal bath, includes, from upstream to downstream: an electric melting zone with a cold-top including electrodes for melting a vitrifiable mixture in order to obtain a bath of glass; a refining and homogenizing zone with a hot-top, including a first convection loop and a second convection loop; and a zone for cooling the glass formed by a conditioning tank which, being passed through by the second convection loop, is connected to at least one flow channel, wherein the hybrid furnace includes at least one tank neck that includes a floor and connects the electric melting zone to the refining and homogenizing zone of the glass and the hybrid furnace includes a non-return separation device to prevent the molten glass in the refining and homogenizing zone from returning to the melting zone.

### TECHNICAL FIELD OF THE INVENTION

The invention relates to a hybrid glass manufacturing furnace with electric melting, for supplying a float unit.

The invention relates more particularly to a hybrid glass manufacturing furnace with electric melting for supplying a float unit, further comprising an electric melting zone with a cold-top for melting a vitrifiable mixture which is connected, via a first tank neck, to a refining and homogenizing zone with a hot-top comprising two glass convection loops in order to obtain, in an appropriate amount, a high-quality glass.

The hybrid glass manufacturing furnace according to the invention is not only able to deliver a high-quality glass having less than 0.1 bubble per liter but is also able to deliver such a glass with a pull rate of at least 400 tons per day in order to supply a float glass unit on a bath of molten metal intended to manufacture flat glass.

### TECHNICAL BACKGROUND

Different example designs of furnaces for the manufacture of glass that depend in particular on the product to be manufactured, that is to say the final shaping of the glass, are known from the prior art.

Thus, different furnace designs are distinguished depending on whether the planned production relates to glass fibers, industrial hollow glass forming, or flat glass.

One of the industrial challenges in the design of glass furnaces is to be able to obtain a glass whose quality requirements depend on the product. In this respect, flat glass production is comparatively one of the most demanding.

Produced in very large quantities, flat glass is used in a wide range of applications thanks to its versatility. It is widely used in the electronics (flat screens), construction and automotive sectors, where it can be processed using a wide variety of techniques (bending, tempering, etc.), making it the base glass for a whole range of glass products.

In view of the quality and quantity issues involved, the present invention is particularly aimed at the manufacture of glass for the industrial forming of such flat glass, which is conventionally obtained by means of a glass float unit on a bath of molten metal, generally tin, reason why such flat glass is still called float glass.

For the manufacture of flat glass, it is expected to be able to feed the float unit with high quality glass, i.e. glass containing as few bubbles as possible, i.e. generally glass with less than 0.5 bubbles/liter.

Glass quality is determined in particular, but not exclusively, by the number of bubbles present in the glass, expressed in “bubbles per liter”. The lower the number of bubbles per liter in a glass, the higher its quality is considered to be.

It should also be remembered that the presence of bubbles (or gaseous defects) in glass is inherent to the glassmaking process, wherein there are generally three successive stages or phases: melting, refining and homogenizing, and thermal conditioning of the glass.

The presence of bubbles in the glass results in the melting step during which a vitrifiable mixture is melted, also called a “batch” (composition). The vitrifiable mixture is made up of raw materials comprising, for example, a mixture of sand, limestone (calcium carbonate), soda ash and dolomite for the manufacture of soda-lime glass (the glass most commonly used for flat glass manufacture), to which cullet is advantageously added, made up of broken glass in order to promote melting.

The vitrifiable mixture is transformed into a liquid mass wherein even the least miscible particles, i.e. those richest in silicon dioxide or silica (SiO₂) and low in sodium oxide (Na₂O), dissolve.

Sodium carbonate (Na₂CO₃) begins to react with grains of sand at 775° C., releasing bubbles of carbon dioxide (CO₂) into a liquid that becomes increasingly viscous as the carbonate transforms into silicate. Likewise, the transformation of limestone grains into lime and the breakdown of dolomite also cause the emission of carbon dioxide (CO₂).

The melting stage is completed when there are no more solid particles in the molten glass liquid, which has become highly viscous and, at this stage of the manufacturing process, is filled with air and gas bubbles.

The refining and homogenization step then makes it possible to eliminate the bubbles present in the molten glass. As is well known, “refining agents” are advantageously used during this stage, i.e. substances in low concentration which, by breaking down at the bath's melting temperature, supply gases which cause the bubbles to swell, thus accelerating their ascent to the surface of the glass.

The thermal conditioning stage of the manufacturing process then makes it possible to lower the temperature of the glass since, at the start of the shaping operation, the viscosity of the glass must generally be at least ten times higher than during refining.

Each of the steps of manufacturing the glass that have just been described naturally corresponds to the structure of a furnace used to carry them out.

Typically, a glass furnace of this type comprises a melting zone wherein the glass batch is melted to form a glass bath, followed by a refining and homogenizing zone to eliminate glass bubbles, and finally a thermal conditioning zone to cool the glass to its forming temperature, which is much lower than the temperatures experienced by the glass during its production.

From the glassmaking process mentioned above, we can see that the melting stage is accompanied by the emission of carbon dioxide (CO₂), one of the main greenhouse gases involved in climate change.

For this reason, efforts are being made to use an ever-increasing proportion of cullet in order to reduce these direct carbon dioxide (CO₂) emissions, as well as the indirect carbon dioxide (CO₂) emissions associated with the raw materials used in the vitrifiable mix.

Indeed, apart from manufacturing of a high-quality glass, as well as industrial challenges of high productivity with the lowest possible cost of furnace construction and operation, one of the other major current challenges which the glass industry must face is ecological, namely the need to find solutions to reduce the carbon footprint (or CO₂ footprint) of the process for producing the glass.

To achieve carbon neutrality, a global approach to the process is preferred, seeking to act in multiple ways to reduce both direct emissions during manufacturing and indirect emissions, as well as upstream and downstream emissions in the value chain, for example those linked to the transport of materials upstream and the product downstream.

These multiple ways therefore include product design and material composition, improving the energy efficiency of industrial processes, using renewable and decarbonized energy, working with raw material suppliers and transporters to reduce their emissions, and finally, exploring technologies for capturing and sequestering residual emissions.

In addition to the direct emissions inherent in the glassmaking process mentioned above, the type of energy used, particularly for the high-temperature melting stage (over 1500° C.), accounts for the largest share of the carbon footprint of the glassmaking process, since it generally involves fossil fuels, most often natural gas or even petroleum products such as fuel oil.

Consequently, research into new furnace designs must not only meet the industrial challenges associated with glass quality, but also reduce the carbon footprint of the glassmaking process, in terms of both direct and indirect carbon dioxide (CO₂) emissions, notably by reducing the use of fossil fuels.

Glassmaking is carried out in furnaces that have constantly evolved since the first pot (or crucible) furnaces, progressing through the Siemens furnace, which is generally considered to be the ancestor of today's large continuous-melt glass furnaces, like cross-fired furnaces that can produce up to 1,200 tons of float glass per day.

The choice of energy used for the melt thus leads to two common large furnace designs for the manufacture of glass, respectively flame furnaces and electric furnaces.

According to the first design, flame furnaces generally use fossil fuels, in particular natural gas for burners; the thermal energy is thus transmitted to the glass by heat exchange between the flames and the surface of the glass bath.

The above-mentioned cross-fired furnaces are an example of a furnace that goes by this first design, and are widely used to supply molten glass to a float unit intended to manufacture flat glass.

According to the second design, electric furnaces are ones wherein the thermal energy is produced by the Joule effect within the mass of the molten glass.

Indeed, an insulating substance at room temperature, the glass becomes electrically conductive at high temperature so that it is possible to envisage using the Joule effect within the glass melts to heat them.

However, electric furnaces are, for example, used for the production of particular glasses such as opal glass with fluorine or lead crystal or are commonly used for the manufacture of glass fibers for thermal insulation.

Indeed, it is commonly accepted by a person skilled in the art that such electric furnaces are not able to supply glass in sufficient quantity or quality (as a reminder less than 0.5 bubble per liter) to a float glass unit on a bath of molten metal intended for the manufacture of flat glass.

Electric furnaces of the prior art known by the Applicant are at most capable of delivering a pull rate of 200 to 250 tons per day of a glass which has at best a few hundred bubbles per liter, more generally a few thousand, which may possibly be suitable for forming hollow glasses, typically bottles, but is in no way the case for the manufacture of flat glass and consequently for supplying a float unit.

It is the reason why flame furnaces (such as cross-fired furnaces) remain today only the furnaces capable of supplying such a float glass unit.

However, flame furnaces rely on the use of fossil fuels, essentially natural gas, so that their carbon footprint is hardly compatible with the objectives of reducing carbon dioxide (CO₂) emissions, i.e. the carbon footprint of the glass production process.

In order to complete the description of furnace designs for manufacturing glass according to the prior art, mention will be made of a “third design” of a furnace, having recently known changes to face in particular to the ecological issue of reducing carbon dioxide emissions (CO₂).

This third furnace design is based on a flame furnace, but uses electrical booster heating, in particular to momentarily increase the production of the furnace or to improve the quality of the glass.

Therefore, such furnaces are also called “electric-boosted flame furnaces”.

The ovens according to this third design thus combine several sources of energy, respectively fossil fuels and electricity, and are therefore also called “hybrid” furnaces.

Adding electrical booster heating makes it possible to improve the melting capacity of flame furnaces which is limited by the heat transfer occurring between the flame and the surface of the glass bath.

However, the operation of such a hybrid furnace is always mainly based on the use of a fossil fuel, typically gas, so that the impact ultimately obtained on improving the carbon footprint of the glass production process remains limited.

Indeed, the electricity is used here only as a booster, so that its impact is proportional. In addition, in order to effectively improve the carbon footprint, the electricity used must still be a so-called “green” electricity, that is an electricity that is produced from sources of renewable and decarbonized energy.

The purpose of the invention is in particular to propose a new design of furnace for the manufacture of glass capable of delivering a high-quality glass and of supplying a float glass unit for manufacturing flat glass, at a level of energy consumption which makes it possible to obtain a significant reduction in the carbon dioxide (CO₂) emissions stemming from the glassmaking process.

### SUMMARY OF THE INVENTION

For this purpose, the invention proposes a hybrid glass manufacturing furnace for supplying a unit for floating the glass on a molten metal bath, said hybrid furnace comprising, from upstream to downstream:
an electric melting zone with a cold-top comprising electrodes for melting a vitrifiable mixture in order to obtain a bath of glass;
a refining and homogenizing zone with a hot-top, comprising a first convection loop and a second convection loop; and
a zone for cooling the glass formed by a conditioning tank which, being passed through by said second convection loop, is connected to at least one flow channel,
   characterized in that the hybrid furnace comprises at least one tank neck which, called the first tank neck, comprises a floor and connects the electric melting zone to the refining and homogenizing zone of the glass and in that said hybrid furnace comprises a “non-return” separation device which, positioned at said first tank neck, is designed to prevent the molten glass in the refining and homogenizing zone from returning to the melting zone.

Advantageously, said first tank neck of the hybrid furnace, combined with the separation device, participates in controlling the temperature of the glass by making it possible to ensure cooling of the glass which flows from the electric melting zone to the refining and homogenizing zone of the glass, whereby a control of the first convection loop and of the second convection loop is obtained, to the ultimate benefit of manufacturing the desired quantity of high-quality glass.

Advantageously, the hybrid furnace comprises means for cooling the glass which are able to selectively cool the glass in the first tank neck. Preferably, the hybrid furnace comprises an air-circulation cooling device.

Advantageously, the means for cooling the glass are able to ensure variable cooling, that is adjustable, in particular determined as a function of the temperature of the glass.

The hybrid furnace according to the invention makes it possible to combine, on the one hand, a high-performance vitrifiable mixture melt in the melting zone and, on the other hand, control of the temperature of the glass introduced into the refining and homogenizing zone, in particular to obtain a flow of the glass therein, respectively with a first convection loop and a second convection loop whereby a high-quality glass is in particular obtained.

Indeed, the separation device limits the amount of molten glass flowing downstream from the melting zone, thus promoting cooling of the glass in the first tank neck and the reason why there is synergy between the separation device and the first tank neck.

Furthermore, the separation device also prevents the glass from returning into the first tank neck, from the refining and homogenizing zone to the melting zone, whereby the molten glass is capable of being cooled in the first tank neck and then refined in the refining and homogenizing zone comprising a first convection loop and a second convection loop.

Advantageously, the separation device ensuring the function of preventing the glass from returning to the electric melting zone comprises a dam and/or at least one elevation of the floor of the first tank neck depending on the embodiments.

According to the invention, the general design of the hybrid furnace with an electric melting zone and a refining zone with two convection loops as well as the first tank neck connecting them and the separation device together make it possible, in other words in combination, to obtain not only a high-quality glass, that is having less than 0.1 bubble per liter, but also to deliver an amount of this glass with a pull rate that is greater than or equal to 400 tons per day in order in particular to be able to supply a float unit.

Thus, the hybrid furnace according to the invention is capable of supplying glass with a forming zone consisting of a float glass unit on a bath of molten metal intended for the manufacture of flat glass.

Advantageously and against the presumptions of the person skilled in the art, the hybrid furnace according to the invention consequently makes it possible to combine high-quality glass and large quantities, doing so with a cold-top electric melting zone (and no longer a flame-melting zone).

In the present invention, electricity thus represents more than 60%, or even 80% and even more, of the total energy used in the hybrid furnace for the glassmaking process.

The furnace according to the invention is said to be “hybrid” by analogy with the third furnace design described above, the term “hybrid” is thus used to qualify it as a result of the use of two different energy sources, respectively electrical energy and fuel energy.

However, the analogy with the present invention does not go beyond this, since electrical energy is the only source of energy used to melt the glass when it is being made, and fuel energy, a fossil fuel or equivalent, is therefore only used in the furnace for refining and homogenizing the glass.

Advantageously, the hybrid furnace according to the invention combines, on the one hand, an electric melting zone with a cold-top and, on the other hand, a refining and homogenizing zone for the glass using flames, i.e. by combustion, preferably with an electric boost, said melting zone and refining zone being separated by the so-called “non-return” separation device keeping the glass away from the melting zone.

By virtue of such a combination, in particular the device for separating and controlling the temperature of the glass entering the refining and homogenizing zone, the hybrid furnace according to the invention makes it possible to obtain a high-quality glass, i.e. comprising less than 0.1 bubble per liter, while being able to deliver it in large quantities so that this glass is advantageously capable of supplying a float glass unit intended for the manufacture of flat glass.

The present invention therefore goes against the presumptions of a person skilled in the art, who would not believe that an electric melting furnace can also make it possible to obtain such a high-quality glass in such quantities.

In the present invention, a high-quality glass is in particular obtained by virtue of the refining and homogenizing step which is carried out after the electrical melting step, said step advantageously being controlled by the cooling of the glass that the first tank neck enables, which cooling participates in obtaining the two convection loops, when controlling the directing of the glass.

Advantageously, the high-quality glass is also obtained by virtue of the separation device which, arranged in the first tank neck of the hybrid furnace, is configured so that there is no return of molten glass from the refining and homogenizing zone to the melting zone.

By virtue of the separation device, the flow of the glass in the first tank neck is a “piston” flow.

Advantageously, the separation device is formed by a dam and/or an elevation of the floor of the first tank neck which are able, respectively, alone or together, to prevent the molten glass from returning from the refining and homogenizing zone to the electric melting zone of the hybrid furnace according to the invention.

In a hybrid furnace according to the invention, by means of said separation device, no convection loop or glass recirculation loop extends from the refining and homogenizing zone to the melting zone.

By comparison, a submerged throat connecting a melting zone to a refining zone is unable to ensure such a function of preventing the glass from returning in a furnace. Indeed, a return current of the glass exists in such a submerged throat, in particular due to the wear of the materials.

In addition, the glass flowing in a submerged throat is not in contact with the atmosphere so that it is also not capable of being cooled in a controlled and variable manner on the surface, in particular by an air circulation cooling device.

By comparison with a submerged throat whose section is limited by construction, the first tank neck additionally allows a flow of the glass with a pull rate which corresponds to supplying a float unit.

According to the invention, the step of refining and homogenizing the glass is carried out on glass that advantageously contains little or no non-molten parts, in particular by virtue of the “non-return” separation device which makes it possible to increase the residence time of the glass in the electric melting zone.

The hybrid furnace according to the present invention consists of a combination of features rather than a juxtaposition, since there are interactions between the technical features, a synergy, in particular between the electric melting zone and the refining and homogenizing zone with two convection loops, thanks to the first tank neck and the associated separation device which are respectively able to allow the glass to cool and to prevent the glass from returning to the melting zone.

By virtue of the first tank neck and the separation device, the temperature of the glass is capable of being controlled separately and precisely in the electric melting zone on the one hand and in the refining and homogenizing zone on the other hand.

Preferably, the length of the first tank neck is configured to obtain cooling, lowering the temperature of the glass intended to subsequently flow into the refining and homogenizing zone.

Indeed, the molten glass obtained by an electric melt generally has higher temperatures, especially compared with flame melting.

By way of example, the temperature of the glass in the melting zone is around 1450° C., whereas the desired temperature for the glass in the downstream part of the first tank neck is more in the order of 1300° C. to 1350° C.

Advantageously, the hybrid furnace comprises glass cooling means arranged in the first tank neck so as to selectively cool the glass, i.e. to control the cooling to actively regulate the glass temperature.

Preferably, the cooling means are formed by at least one air circulation cooling device, the air being introduced into the atmosphere of the first tank neck to come into contact with the surface of the glass bath and extracted in order to remove the heat (calories) transmitted to the air by the glass.

Alternatively, the cooling means are immersed in the glass flowing from upstream to downstream through the first tank neck in order to allow the cooling thereof.

Such cooling means immersed in the glass are for example formed by the dam which, forming all or part of the separation device, is cooled by a cooling circuit with heat transfer fluid, in particular a circuit of the “water jacket” type.

According to another embodiment, the cooling means are formed by vertical studs arranged in the first tank neck and immersed in the glass which are cooled by a cooling circuit with heat transfer fluid in order to remove the heat transmitted by the glass.

According to yet another embodiment, the cooling means are able to cool the structure of the first tank neck in contact with the glass, the cooling being carried out from the outside of the structure of the first tank neck.

Of course, the cooling means associated with the first tank neck according to the various examples that have just been given are able to be implemented alone or in combination.

Advantageously, the means for cooling the glass associated with the first tank neck make it possible to selectively control the temperature of the glass, a temperature which is likely to vary, in particular when the pull rate varies, as an increase in the pull rate causes an increase in the temperature of the glass.

By comparison with such means for cooling the glass associated with the first tank neck, such a variable cooling of the glass would not be possible with a submerged throat.

Advantageously, the hybrid furnace according to the invention employs electrical energy for the melting of the vitrifiable mixture and relies on the increasing availability of “green” electricity, for example obtained from wind energy, solar energy, etc. rather than from fossil fuels such as coal or oil.

Advantageously, the fuel energy used in the burners of the refining and homogenizing zone is not a fossil fuel such as natural gas but another equivalent fuel energy, preferably hydrogen, or alternatively bio-methane.

The hybrid furnace according to the invention is consequently capable of addressing not only the issue of the high quality of glass and of pull rate respectively required to supply a float unit, but also ecological issues, in order to allow a reduction in the carbon footprint of the glassmaking process.

According to other characteristics of the furnace according to the invention:
the separation device comprises a dam intended to be partially submerged in the glass bath;
   the separation device consists solely of a dam able to prevent the molten glass from returning from the refining and homogenizing zone to the melting zone, preferably said dam is positioned at the upstream end of the first tank neck;
the separation device comprises at least one elevation of the floor of the first tank neck;
   the separation device consists solely of an elevation of the floor capable of preventing the molten glass from returning from the refining and homogenizing zone to the melting zone;
   the separation device ensuring the function of preventing the glass from returning to the melting zone comprises a dam and/or at least one elevation of the floor;
   the separation device ensuring the function of preventing the glass from returning to the melting zone comprises a dam combined with said at least one elevation of the floor;
said at least one elevation of the floor comprises, from upstream to downstream, at least one ascending section, a top section and a descending section;
the dam is arranged in the first tank neck above the top section of the elevation of the floor;
at least one of said ascending section and descending section of said at least one elevation of the floor is inclined relative to the horizontal and/or comprises a top section;
said at least one elevation has a maximum height that determines, in whole or in part, a passage section of the molten glass in the first tank neck;
the dam is mounted movably vertically to allow adjustment of the depth of its immersion in the glass bath;
   the dam, alone or in combination with said at least one elevation, determines a section of the passage of the molten glass capable of varying as a function of the adjustment of the depth of said dam;
the dam is removable, that is to say detachable, in order in particular to allow its replacement in the event of wear and to facilitate the maintenance of the furnace;
the hybrid furnace comprises at least one atmospheric separation means, such as a vertical partition, which is able to separate the atmosphere from the electric melting zone with a cold-top and the atmosphere of the refining and homogenizing zone with a hot-top;
the hybrid furnace comprises blocking means which, arranged at the upstream end of the first tank neck, are able to retain the vitrifiable mixture layer in the electric melting zone so that said vitrifiable mixture present on the surface of the glass bath does not penetrate into the first tank neck;
the means for blocking the vitrifiable mixture layer are formed by the dam;
the blocking means are formed by the separation means whose free end extends to the surface of the bath, or is immersed in the glass bath;
the blocking means are distinct from said separation means, said blocking means being attached to or remote from the separation means;
the hybrid furnace comprises means for cooling the glass which are able to cool the glass in the first tank neck, in particular at least one air-circulation cooling device;
   the hybrid furnace comprises a charging zone wherein a charging device is arranged to introduce said vitrifiable mixture into the electric melting zone;
   the charging device is configured to deposit the vitrifiable mixture over the entire surface of the glass bath so as to form an insulating layer between the glass bath and the top of the melting zone;
the electrodes are arranged on the surface so as to dip into the vitrifiable mixture, said diving electrodes preferably extending vertically;
the electrodes are arranged through a floor of the melting zone so as to be immersed in the vitrifiable mixture, said rising electrodes preferably extending vertically;
   the hybrid furnace comprises diving electrodes and/or rising electrodes;
the electric melting zone advantageously comprises a low-convection zone, called the buffer zone, located between the free end of the immersed electrodes and a floor of the melting zone;
the melting zone is configured to have a determined depth so as to obtain said low-convection buffer zone, preferably the depth is greater than 600 mm, or even preferentially greater than 800 mm;
the first convection loop and the second convection loop are separated by a loop inversion zone determined by a hot spot or source corresponding to the hottest point of the glass;
the refining and homogenizing zone comprises at least one burner which is arranged to obtain said hot spot determining said loop inversion zone;
the hybrid furnace comprises a barrier which is arranged in said loop inversion zone;
   the hybrid furnace comprises a variation in the depth of the floor relative to a surface of the glass in the refining and homogenizing zone, preferably at least one elevation, or even a change in level, said depth variation being situated in the part comprising the first convection loop and/or in the part comprising the second convection loop;
the hybrid furnace comprises modulation means such as electric boosting and/or bubblers which, arranged in the refining and homogenizing zone, are able to make it possible to modulate the convection of said loops in order to facilitate the driving of the manufacture of the glass;
the conditioning tank of the cooling zone comprises, from upstream to downstream, a tank neck, called the second tank neck, then a working end;
   after the conditioning tank, no return current takes place in the flow channel intended to supply high-quality glass to a forming zone comprising said float unit; in other words, the flow of the glass in the channel is a flow of the “piston” type;
the hybrid furnace is configured to supply glass to said float glass unit intended to manufacture flat glass with a pull rate greater than or equal to 400 tons per day, preferably between 600 and 900 tons per day, or even 1000 tons per day or more, said high quality glass having less than 0.1 bubble per liter, preferably less than 0.05 bubble per liter.

The invention further proposes an assembly for the manufacture of flat glass comprising a hybrid glass manufacturing furnace and a float glass unit on a bath of molten metal which, arranged downstream, is supplied with glass by said furnace via at least one flow channel.

### BRIEF DESCRIPTION OF THE FIGURES

Further characteristics and advantages of the invention will become apparent upon reading the following detailed description, for the understanding of which reference is made to the appended drawings, wherein:

FIG. 1 is a side view which represents a hybrid glass manufacturing furnace according to a first embodiment of the invention comprising an electric melting zone with a cold-top connected by a first tank neck to a refining and homogenizing zone with a hot-top, comprising a first convection loop and a second convection loop and then a cooling zone passed through by said second convection loop and which further illustrates a dam forming a “non-return” separation device arranged at said first tank neck;

FIG. 2 is a top view which shows the furnace according to FIG. 1 and which shows the electric melting zone connected to the refining and homogenizing zone by the first tank neck wherein the dam is arranged, designed to prevent the molten glass from returning from the refining and homogenizing zone to the electric melting zone;

FIG. 3 is a side view that, similar to FIG. 1, shows a hybrid furnace according to a second embodiment of the invention wherein the separation device is formed by a dam and at least one elevation of the floor of the first tank neck and which shows the dam associated with said elevation respectively configured to prevent the molten glass from returning from the refining and homogenizing zone to the electric melting zone of the furnace;

FIG. 4 is a top view which, similar to FIG. 2, shows the hybrid furnace according to FIG. 3 and which shows the preferably movable dam associated with the elevation of the floor in the first tank neck connecting the melting zone to the refining and homogenizing zone;

FIG. 5 is a side view that, similar to FIGS. 1 and 3, shows a hybrid furnace according to a third embodiment of the invention wherein the separation device is only formed by an elevation of the floor of the first tank neck and which thus illustrates an elevation which, having a greater height than in the second mode, is configured to prevent a return of molten glass, without a dam,

FIG. 6 is a side view that shows in detail the part of the hybrid furnace according to FIG. 5 and which shows a variant embodiment of the elevation of the floor of the first tank neck comprising a descending section, forming an inclined plane, able to ensure a gradual variation in the depth of the molten glass toward the refining and homogenizing zone.

### DETAILED DESCRIPTION OF THE INVENTION

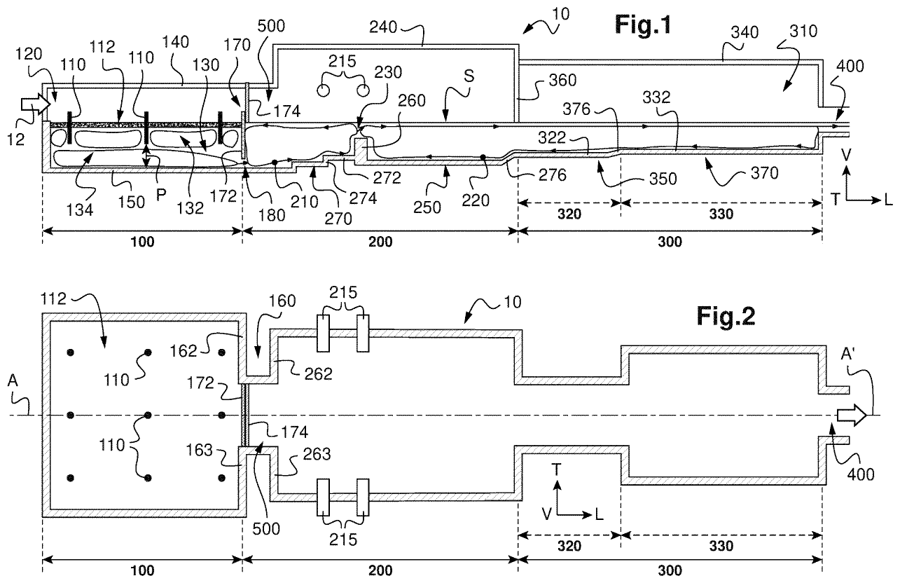

In the remainder of the description, the longitudinal, vertical, and transverse directions will be used without limitation in reference to the axis system (L, V, T) shown in FIGS. 1 to 6.

Use will also be made, without limitation, of the terms “upstream” and “downstream” when referring to the longitudinal direction, as well as “upper” and “lower” or “top” and “bottom” when referring to the vertical direction and finally “left” and “right” when referring to the transverse direction.

In the present description, the terms “upstream” and “downstream” correspond to the direction of flow of the glass in the furnace, the glass flowing from upstream to downstream along a longitudinal median axis A-A′ of the hybrid furnace (upstream from A, downstream from A′) shown in FIGS. 2 and 4.

Furthermore, the term “loop” is used here in connection with the recirculation of the glass in the furnace being well known to the skilled person, just like the concepts of “cold-top” and “hot-top” for a glassmaking furnace.

FIGS. 1 and 2 are respectively side and top views (which are not to scale) of a hybrid glass manufacturing furnace 10 showing a first embodiment of the present invention.

As indicated above, by analogy with the third furnace design described above, the term “hybrid” is used here to refer to the furnace according to the invention due to the use of two different energy sources, respectively electrical energy and fuel energy, during the glassmaking process in the furnace.

However, the analogy with the present invention does not go beyond this, since on the one hand, the electrical energy (constituting the first source) is the sole source of energy used to obtain the melting of the glass and, on the other hand, the fuel energy (constituting the second source), of the fossil or equivalent type, is used only for refining and homogenizing the glass.

The hybrid furnace 10 according to the invention is in particular intended to supply a float glass unit on a bath of molten metal, generally tin, for the manufacture of flat glass.

As shown by FIGS. 1 and 2, the hybrid furnace 10 successively comprises from upstream to downstream, along said longitudinal median axis A-A′ of the furnace, at least one electric melting zone 100, a refining and homogenizing zone 200 and a glass cooling zone 300.

According to a first characteristic of the hybrid furnace 10 according to the invention, the melting zone 100 of the hybrid furnace 10 is electrical.

Advantageously, the electric melting zone 100 is of the “cold-top” type.

Advantageously, the step of melting the glass is obtained by using only electrical energy during the manufacture of the glass, in comparison with hybrid furnaces of the prior art wherein the melting step is obtained by means of fuel energy, and as a booster, electrical energy.

The electric melting zone 100 comprises electrodes 110 for melting a vitrifiable mixture (or “batch”) which consists of the raw materials and cullet in order to obtain a glass bath 130.

In a known manner, the cullet is made up of glass debris which, obtained by recycling the glass, are ground and cleaned before being subsequently added to the raw materials in order to produce glass again.

Advantageously, the cullet promotes melting, that is to say the transformation by melting of the vitrifiable glass mixture.

In addition, the cullet makes it possible to upgrade the glass used by recycling it (the glass being recyclable ad infinitum), thus reducing the quantities of raw materials needed to manufacture glass, and helping to reduce the carbon footprint of the glassmaking process.

The hybrid furnace 10 comprises a charging zone 120 wherein a charging device 12 is arranged (also called a batch charger) which is intended to introduce the vitrifiable mixture into the electric melting zone 100, said charging device 12 being schematically shown by an arrow in FIG. 1.

Advantageously, the charging device 12 is configured to deposit the vitrifiable mixture over the entire surface of the glass bath 130 so as to form an insulating layer 112 between the glass bath 130 and a top 140 of the electric melting zone 100, which is why the latter is called “cold-top”.

Preferably, the glass bath 130 is uniformly covered with a layer 112 consisting of vitrifiable mixture, for example from 10 to 40 cm thick, below which the complex chemical reactions take place, which, as described in the preamble of the application, lead to the molten glass being obtained.

In the cold-top electric melting zone 100, the power dissipated around the electrodes 110 generates a high-convection zone 132 comprising in particular very intense rising currents which provide the necessary calories at the boundary between the cast iron and the vitrifiable mixture forming said vitrifiable mixture layer 112.

In the glassmaking process according to the prior art, besides carbon dioxide (CO₂), the decomposition of the raw materials and the use of a fossil energy as fuel for the melting step are also the source of polluting emissions consisting essentially of nitrogen oxide (NOx), sulfur oxide (SOx), halogens and dust.

Advantageously, the absence of combustion (flames) in the cold-top electric melting zone 100 of the hybrid furnace 10 according to the invention results in the NOx and SOx pollution rate being comparatively very low.

Furthermore, although permeable to carbon dioxide (CO₂), the vitrifiable mixture layer 112 present on the surface of the bath 130 advantageously makes it possible to trap by condensation or by chemical reactions the vapors, which are sometimes toxic depending on the composition, emitted by the molten glass.

Advantageously, the electrodes 110 are arranged on the surface so as to dip into the glass bath 130, through the layer 112 covering the surface of the bath 130 as shown by FIG. 1.

Preferably, the diving electrodes 110 extend vertically. Alternatively, the diving electrodes 110 extend obliquely, that is, are inclined so as to have a given angle relative to the vertical orientation.

Alternatively, the electrodes 110 are arranged through a floor 150 of the electric melting zone 100 so as to be immersed in the bath 130, the rising electrodes (as opposed to the diving electrodes) extending preferably vertically, alternatively obliquely.

By comparison with electrodes arranged through the floor 150, the diving electrodes 110 also allow easier control of their state of wear and lead to a dissipation of the electrical energy which is advantageously closer to the melting interface, from the layer 112 of vitrifiable mixture.

Advantageously, the diving electrodes 110 make it possible, by comparison with rising electrodes, to retain a floor 150 of the electric melting zone 100 which is free of any openings.

Preferably, the floor 150 of the electric melting zone 100 is flat as shown in FIG. 1.

As a variant, the floor 150 comprises at least one variation in depth relative to the surface of the bath 130 of glass, said variation comprising at least one elevation and/or at least one change in level.

Preferably, the fusion electrodes 110 are evenly distributed in the bath 130. Moreover, the number of nine electrodes 110 shown here in FIGS. 1 and 2 is only an illustrative example and is therefore in no way limiting.

Alternatively, the electric melting zone 100 could cumulatively comprise the submerged electrodes and rising electrodes.

According to another alternative arrangement, the electrodes 110 pass through at least one side wall delimiting said electric melting zone 100, said electrodes 110 then extending horizontally and/or obliquely.

Advantageously, the 110 electrodes are made of molybdenum, this refractory metal withstanding temperatures of 1700° C., being particularly suitable for melting glass using the Joule effect, as glass only becomes conductive at high temperatures.

Advantageously, the electric melting zone 100 comprises a zone of low convection, called the buffer zone 134, which is situated between the free end of the diving electrodes 110 and the floor 150.

The electric melting zone 100 is thus configured to present, below the diving electrodes 110, a depth (P) determined so as to obtain such a low-convection buffer zone 134.

Preferably, the depth (P) between the free end of the diving electrodes 110 and the floor 150 is greater than 600 mm, preferably greater than 800 mm.

Such a low-convection buffer zone 134 constitutes another reason to prefer the diving electrodes 110 relative to rising electrodes passing through the floor 150.

Advantageously, the presence of a low-convection buffer zone 134 participates directly in obtaining a high-quality glass by promoting a longer residence time of the glass in the melting zone 100.

Advantageously, the electric melting zone 100 and the zone 200 for refining and homogenizing the glass are connected to each other by a first tank neck 160, that is to say a zone of reduced width, as shown by FIG. 2.

Advantageously, said first tank neck 160 of the hybrid furnace makes it possible to ensure cooling of the glass when the glass flows from the electric melting zone 100 to the zone 200 for refining and homogenizing the glass.

The cooling of the glass will be all the more significant since the first tank neck will have a large length, the glass coming from the melting zone 100 cooling naturally during its flow from upstream to downstream through the first tank neck 160.

Advantageously, the hybrid furnace 10 comprises means 500 for cooling the glass capable of selectively cooling the glass in the first tank neck 160.

In addition to the cooling of the glass during its flow through the first tank neck 160 connecting the melting zone 100 to the refining zone 200, such cooling means 500 make it possible to further increase the cooling and especially to vary this cooling by virtue of which a regulation of the temperature of the glass is then advantageously obtained.

Preferably, the means 500 for cooling the glass in the first tank neck 160 comprise at least one air-circulation cooling device 510.

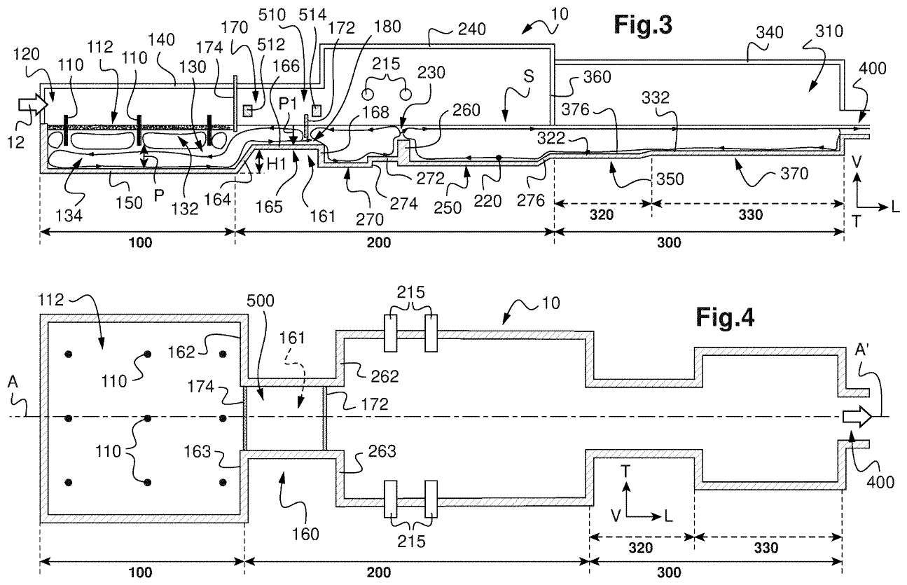

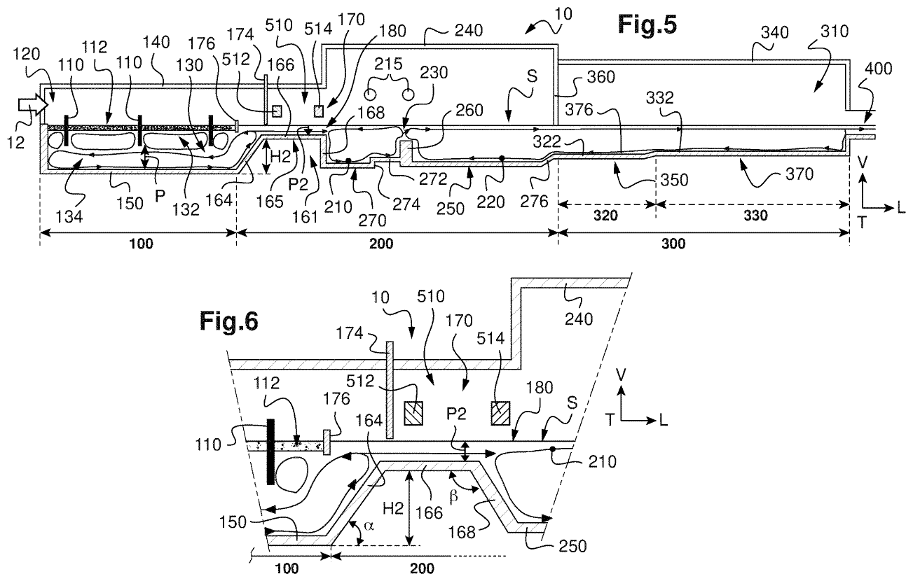

An example embodiment of a cooling device 510 such as more particularly shown schematically in FIGS. 3 and 4 is described below, showing a second embodiment and in FIGS. 5 and 6 respectively showing a third embodiment and a variant, so that reference will advantageously be made to said Figures.

Such an air-cooling device 510 for the glass comprises for example at least intake means 512 for introducing cooling air into the atmosphere of said first tank neck 160 of the hybrid furnace 10.

Preferably, the device 510 for cooling the glass comprises discharge means 514 arranged in the first tank neck 160 to discharge the hot air and ensure its renewal by fresh cooling air.

Alternatively, the discharge means are formed by extraction means (not shown) which, located downstream of the first tank neck 160, are intended to extract fumes. Advantageously, the hot air is then discharged with the fumes by said extraction means without the hybrid furnace 10 having to be equipped with additional means.

The intake means 512 and the air discharge means 514 of the glass cooling device 510 are for example formed by one or more openings emerging in the side walls supporting the top of the first tank neck 160.

Said at least one inlet opening and said at least one discharge opening schematically shown in FIG. 3 and above are for example situated longitudinally opposite one another, the intake opening(s) being arranged in the upstream part of the first tank neck 160 while the discharge opening(s) are arranged in the downstream part of the first tank neck 160.

The intake means 512 and the air discharge means 514 are for example arranged transversely on either side of the first tank neck 160, alternatively on only one of the sides of the first tank neck 160.

Advantageously, the temperature of the cooling air introduced into the first tank neck 160 is lower than the temperature of the hot air located inside said first tank neck 160, the cooling air circulated forming a heat-transfer fluid.

Preferably, the cooling air used is atmospheric air taken outside the hybrid furnace 10, or even outside the enclosure of the building wherein said hybrid furnace 10 is installed, supplying a float unit.

Advantageously, the temperature of the atmospheric air used is controlled so that it can be regulated. For example, the air can be pre-cooled or reheated before being introduced to control its temperature.

Glass cooling is mainly achieved by convection, with the cooling air introduced heating up as it comes into contact with the surface of the glass, before being removed along with the heat (calories) transmitted by the glass.

Advantageously, the circulation of air is able to be controlled by means of air blowing means (not shown) such as fans which, associated with said intake and/or discharge means, are able to be controlled to vary the flow rate of air circulating.

According to another embodiment, the means 500 for cooling the glass are immersed in the glass flowing from upstream to downstream through said first tank neck 160 in order to allow the cooling thereof.

Such cooling means are for example formed by vertical studs immersed in the glass which are cooled by a cooling circuit with heat transfer fluid in order to evacuate the heat transmitted to the studs by the glass.

According to yet another embodiment, the cooling means 500 are able to cool the structure of the first tank neck 160 in contact with the glass, the cooling being carried out from the outside of the structure of the first tank neck 160.

Of course, the cooling means 500 associated with the first tank neck 160 such as those according to the various examples that have just been described are able to be implemented alone or in combination.

Advantageously, the means 500 for cooling the glass associated with the first tank neck 160 make it possible to selectively control the temperature of the glass, a temperature which is likely to vary, in particular when the pull rate varies, as an increase in the pull rate causes an increase in the temperature of the glass.

FIG. 2 shows an example embodiment of the first tank neck 160 connecting the electric melting zone 100 to the refining and homogenizing zone 200.

The passage from the electric melting zone 100 to the first tank neck 160 involves an abrupt narrowing of the width and of the passage section of the glass, for example here by walls 162 and 163 forming an angle of 90° with the longitudinal median axis A-A′ of the furnace.

The passage from the first tank neck 160 to the zone 200 for refining and homogenizing the glass involves an abrupt widening of the passage section of the glass, for example here by walls 262 and 263 forming an angle of 90° with the longitudinal median axis A-A′ of the furnace.

Alternatively, the angle at the inlet of the first tank neck 160 could have a value that is greater than 90° so that the narrowing of the width is less abrupt and more gradual, and likewise the value of the angle at the outlet of the first tank neck 160 could be chosen so that the widening is also less abrupt and more gradual along the median longitudinal axis A-A′ of the furnace.

Advantageously, the molten glass flowing from upstream to downstream via the first tank neck 160 is taken from the lower part of the electric melting zone 100, either from the bottom, the glass there being by comparison “cooler” than in the high-convection zone 132 located between the electrodes 110.

In this first embodiment, the first tank neck 160 comprises a floor (not referenced) which is preferably flat so that said floor of the first tank neck 160 extends horizontally in the extension of the flat floor 150 of the electric melting zone 100.

According to the invention, the hybrid furnace 10 comprises a “non-return” separation device 170 which, positioned at said first tank neck 160, is configured to prevent the molten glass from returning from the refining and homogenizing zone 200 to the melting zone 100.

The separation device 170 according to the first embodiment of the hybrid furnace 10 shown by FIGS. 1 and 2 will be described in more detail later.

According to a second characteristic of the hybrid furnace 10 according to the invention and as opposed to the cold-top electric melting zone 100, the refining and homogenizing zone 200 of the hybrid furnace 10 is of the “hot-top” type.

The refining and homogenizing zone 200 of the hybrid furnace 10 is configured to eliminate the bubbles (or gaseous defects) present in the molten glass coming from the electric melting zone 100 in order to obtain a glass which is of high quality, and this especially makes it possible to supply a float glass unit.

To do this, the refining and homogenizing zone 200 comprises a first convection loop 210, called the upstream recirculation loop, and a second convection loop 220, called the downstream recirculation loop.

Preferably, the first convection loop 210, called the upstream recirculation loop, is longitudinally shorter than the second convection loop 220 as shown in FIG. 1.

Advantageously, the convection currents in the glass corresponding to said loops 210, 220 stir the glass, eliminating bubbles and increasing the residence time of the glass in the refining and homogenizing zone 200, thus helping to obtain high-quality glass.

The first convection loop 210 and the second convection loop 220 are separated by an inversion zone 230 of the loops 210, 220 which is determined by a hot spot (also called “source point”) which corresponds to the hottest point of the glass in the refining and homogenizing zone 200, generally at a temperature of greater than 1500° C.

The refining and homogenizing zone 200 comprises at least one burner 215, preferably here two aerial burners 215 which are arranged under an arch 240 to obtain said hot spot determining the inversion zone 230 of said loops 210, 220.

In the refining and homogenizing zone 200, part of the thermal energy released by the combustion is transmitted directly to the glass by radiation and convection, another part is transmitted by the arch 240 which returns it to the glass by radiation, and which in particular for this reason is called “hot-top”.

Preferably, the burners 215 of the refining and homogenizing zone 200 are cross-fired burners shown schematically in FIG. 2.

Thus, the heating of the glass in the refining and homogenizing zone 200 is obtained by the flames of the burners 215 which develop by combustion above the surface S of the glass.

In a hybrid furnace 10 according to the invention, after it is used for manufacturing, the step of melting the glass carried out in the melting zone 100 is obtained only with electrical energy.

Advantageously, the heating of the glass at the surface produced by combustion of a fossil energy or equivalent fuel in said zone 200 is therefore intended only to carry out the step of refining and homogenizing the glass taken from said melting zone 100.

By comparison, in particular with a hybrid furnace according to the third design described above, the equivalent fossil energy or fuel used by the burners 215 for combustion does not participate in the melting step so that this fuel energy is in the invention used as a “booster” relative to the electrical energy further used for melting.

Therefore, a hybrid furnace 10 according to the invention makes it possible to significantly reduce the share of the fuel energy relative to the electrical energy in the glassmaking process, with electrical energy becoming the main energy and fuel energy becoming the secondary or auxiliary energy.

Advantageously, electricity represents more than 60%, or even 80% and even more, of the total energy used in the hybrid furnace for the glassmaking process.

Therefore, it will be understood that the design of the hybrid furnace 10 according to the invention is particularly advantageous to reduce the carbon footprint when, on the one hand, the combustible energy is a fossil energy such as gas and, on the other hand, the electrical energy is wholly or partly a “green” electricity obtained from renewable and decarbonized energy.

The refining and homogenizing zone 200 can comprise more than two burners 215, in particular burners upstream and/or downstream of said inversion zone 230 which, also positioned above the surface S of the glass, are able to heat said surface S of the glass in order to perfect the refining and the homogenization of the glass by removing the bubbles (or gaseous defects) present in the molten glass.

Indeed, by adjusting the power of the burners 215, it is possible to adjust the longitudinal distribution of the temperatures and therefore the position of the hot spot which is an important parameter for furnace operation.

The burners 215 produce a flame by combustion which can be obtained in a known manner by combining different types of fuel and oxidant but the choice of which also has direct consequences in the carbon footprint of glassmaking, or direct and indirect emissions of greenhouse gases which are linked to the manufacture of the product, in particular carbon dioxide emissions (CO₂).

For combustion by the burners 215 in the refining and homogenizing zone 200, the oxygen present in the air is generally used as oxidant, which can be enriched with oxygen to obtain over-oxygenated air, or even virtually pure oxygen is used in the particular case of oxycombustion.

Generally, the fuel used is natural gas. However, in order to further improve the carbon balance, use will advantageously be made of a bio-fuel, in particular a “biogas”, that is to say a gas composed essentially of methane and carbon dioxide which is produced by methanization, i.e. the fermentation of organic materials in the absence of oxygen, or even preferentially “bio-methane” (CH₄).

More preferably, hydrogen fuel (H₂) will be used which, compared to biogas, advantageously comprises no carbon.

Advantageously, the hybrid glass manufacturing furnace 10 according to the invention may comprise regenerators made of refractory materials operating (for example in pairs and in inversion) or air/fume metal exchangers (also called recuperators) which respectively use the heat contained in the flue gases resulting from the manufacturing to preheat the gases and thus improve the combustion.

As indicated above, the hybrid furnace 10 according to the invention comprises a separation device 170 which is configured to prevent the molten glass from returning from the refining and homogenizing zone 200 to the melting zone 100.

The separation device 170 is positioned at the first tank neck 160, that is between the refining and homogenizing zone 200 and the melting zone 100, to ensure the “non-return” function of the glass from the first convection loop 210 of the glass.

In this first embodiment, the separation device 170 comprises a dam 172 which is intended to be partially submerged in the bath 130 of molten glass as shown by FIGS. 1 and 2.

More specifically, the separation device 170 according to the first embodiment is only constituted by the dam 172, which is advantageously able to prevent the molten glass from returning from the refining and homogenizing zone 200 to the melting zone 100.

Preferably, the dam 172 is positioned at the upstream end of the first tank neck 160.

Advantageously, the dam 172 forming said separation device 170 makes it possible to increase the residence time of the glass in the electric melting zone 100, which contributes to obtaining a high-quality glass.

Preferably, the dam 172 extends transversely over the entire width of the first tank neck 160 as shown by FIG. 2.

Advantageously, the dam 172 is mounted to move vertically to make it possible to adjust the submersion depth in the glass bath 130 so that the section 180 of the passage of the molten glass located below is capable of varying as a function of the adjustment of the depth of the dam 172.

Alternatively, the dam 172 is fixed so that the section 180 of the passage of the molten glass is then constant, i.e. determined by the depth of immersion of said dam 172 in the glass bath 130.

Advantageously, the dam 172 arranged upstream of the first tank neck 160 ensures an immobilization of the layer 112 of vitrifiable mixture covering the bath 130 of glass in the cold-top electric melting zone 100 relative to the hot-top refining and homogenizing zone 200.

Preferably, the delimitation of the vitrifiable mixture layer 112 is thus ensured by the dam 172 which extends to this end vertically above the surface of the glass bath 130 as shown by FIG. 1.

Preferably, the dam 172 is removable, that is to say dismountable, so that said dam 172 is able to be changed, or repaired, in particular due to the wear occurring in contact with the glass, thus facilitating the maintenance of the hybrid furnace 10.

The dam 172 is for example made of non-refractory metal or alloy, said dam 172 then being able to be cooled by a cooling fluid cooling circuit (not shown), in particular a circuit of the water jacket type.

Advantageously, the dam 172 helps to cool the glass in the first tank neck 160 by limiting the flow in the first tank neck 160 and thanks to the water-jacket cooling fluid cooling circuit, which removes some of the heat (calories) transmitted by the glass to the dam 172.

Alternatively, the dam 172 is made of refractory material, typically ceramic, for example an electrofused refractory “AZS” (acronym for Alumina-Zircon-Silica) or a refractory metal such as molybdenum.

The hybrid furnace 10 further comprises at least one separation means 174 for separating the atmosphere from the cold-top electric melting zone 100 and the atmosphere of the hot-top refining and homogenizing zone 200 comprising in particular fumes.

Advantageously, such a separation means 174 makes it possible to isolate the atmosphere from the first tank neck 160 from that of the melting zone 100, in particular when an air cooling device is implemented as a means for cooling the glass in the first tank neck 160.

Preferably, the separation means 174 is formed by a partition (or a curtain) constituting an element attached to the superstructure of the hybrid furnace 10.

The set of blocks in contact with the glass is conventionally called the “substructure”, and the “superstructure” is all of the materials arranged above the substructure.

Since the superstructure material, above the tank blocks of the substructure and is not in contact with the glass but with the atmosphere inside the furnace, is generally of a different nature than that of the tank blocks of the substructure.

Even if the material used for the superstructure is identical to that of the substructure, for example in the case of a hot-top, these two parts of a furnace structure are generally distinguished from each other.

Alternatively, the separation means 174 consists of a part of the superstructure, for example a double U-shaped partition opening outwardly.

Advantageously, the dam 172 is then mounted between the two wings of the “U” of the partition, or in the hollow bottom portion connecting them.

Preferably, the dam 172 and the atmospheric partition 174 are in this first embodiment structurally distinct, independent elements.

Preferably, the partition 174 is not in contact with the surface of the glass but in contact with the dam 172 in order to establish said separation.

Advantageously, the partition 174 is for example located behind as shown in FIG. 1, i.e. downstream of the dam.

Alternatively, the partition 174 is located in front of, i.e. upstream of the dam 172 or located in the same vertical plane.

Alternatively, the dam 172 and the partition 174 are made of a single piece, thus ensuring a double function, on the one hand the first function of separating the glass between the melting zone 100 and the refining and homogenizing zone 200 and, on the other hand, a function of separating the atmosphere of the melting zone 100 with a cold-top 140 and the atmosphere of the refining and homogenizing zone 200 with a hot-top 240.

Alternatively (not shown), if the dam 172 is not arranged upstream of the first tank neck 160 as shown by FIG. 1, the hybrid furnace 10 then advantageously comprises blocking means, also called “skimming”, which are able to retain the vitrifiable mixture layer 112 in the electric melting zone 100.

Preferably and like the dam 172, the blocking means are arranged at the upstream end of the first tank neck 160 so that said vitrifiable mixture present on the surface of the glass bath 130 does not penetrate into the first tank neck 160.

In the first embodiment, besides the anti-return function of the glass, the dam 172 also ensures the function of such blocking means by advantageously retaining the vitrifiable mixture layer 112 in the electric melting zone 100.

An example embodiment of such blocking means will be described in more detail below, under the reference 176, in the second embodiment shown by FIGS. 3 and 4 and the third embodiment shown in FIG. 5.

In the first embodiment shown by FIGS. 1 and 2, the hybrid furnace 10 advantageously comprises a barrier 260 or weir wall which is arranged in said loop inversion zone 230.

Preferably, the barrier 260 extends vertically from the floor 250 of the refining and homogenizing zone 200.

As shown in FIG. 1, the barrier 260 comprises a plateau part that, immersed below the surface S of the glass, determines the passage of the glass from the first convection loop 210, called the upstream recirculation loop, toward the second convection loop 220, called the downstream recirculation loop.

Preferably, the hybrid furnace 10 comprises modulation means (not shown) such as electric boosting and/or bubblers which, arranged in the refining and homogenizing zone 200, are able to make it possible to modulate the convection of said loops 210, 220 in order to facilitate the glassmaking process.

Advantageously, the modulation means therefore comprise electric boosting, i.e. means of additional electrical heating comprising electrodes and/or bubblers, i.e. a system for injecting at least one gas, such as air or nitrogen, at the floor, the bubbles of which then create an upward movement of the glass.

Preferably, the hybrid furnace 10 comprises at least one variation 270 of the depth, relative to the surface S of the glass, of a floor 250 located in the refining and homogenizing zone 200.

The depth variation 270 is located in the part comprising the first convection loop 210 and/or in the part comprising the second convection loop 220.

Advantageously, the depth variation 270 of glass is for example constituted by at least one elevation of the floor 250, or even here several elevations which are shown by the FIG. 1. Alternatively, the depth variation 270 is constituted by at least one difference in level of the floor 250.

The elevation of the floor 250 forming the depth variation 270, i.e. here a reduction of the depth, is for example constituted by at least one step 272, or even two steps.

The depth variation 270 can be more or less gradual, for example via a straight section 274 in the case of the two steps 272 located upstream of the barrier 260, or alternatively via an inclined section 276 as shown, for example, in the case of the step 322 located downstream of the barrier 260, at the junction of the refining and homogenizing zone 200 and the glass cooling zone 300.

Preferably, the cooling zone 300 therefore also comprises a variation 370 of depth which is formed by an elevation.

As shown in FIG. 1, the variation 370 of depth in the cooling zone 300 comprises, for example, the step 322, located in the second tank neck 320, to which the inclined junction 276 leads from the floor 250, and another step 332, which is located in the working end 330, downstream of the step 322.

The step 322 also is connected gradually to the other step 332 by an inclined portion 376 that is situated at the junction between the second tank neck 320 and the working end 330.

Alternatively, the respectively straight and inclined portions that have just been described with reference to FIG. 1 could be reversed between the steps 272 on the one hand and the steps 322, 332 on the other hand, or else only of one and the same type, that is to say either straight or inclined.

As shown in FIG. 1 and as has just been described with the successive steps 322 and 332, the cooling zone 300 comprises a floor 350 which is configured so that the depth relative to the glass surface S gradually decreases from upstream to downstream, from the barrier 260.

According to a third characteristic of the invention, the hybrid furnace 10 comprises, downstream of the refining and homogenizing zone 200, said zone 300 for cooling the glass which is passed through by the second convection loop 220, called the downstream recirculation loop.

The cooling zone 300 is formed by a conditioning tank 310 which communicates with at least one flow channel 400 intended to supply high-quality glass, a float glass unit on a bath of molten metal (not shown) located downstream and forming a forming zone.

Advantageously, the conditioning tank 310 of the cooling zone 300 comprises, from upstream to downstream, a second tank neck 320 then a working end 330.

Advantageously, the atmosphere of the refining and homogenizing zone 200 and the colder atmosphere of the cooling zone 300 are separated from each other by a heat screen 360 extending vertically from a top 340 to the vicinity of the surface S of the glass, preferably without tempering in the glass.

Advantageously, in any vertical plane transverse to the longitudinal median axis A-A′ of the furnace, there exists in the conditioning tank 310, points in the glass having a longitudinal velocity component running from downstream to upstream.

After the conditioning tank 310, no return current takes place in the flow channel 400 intended to supply glass to the forming zone, in other words the flow of the glass in the channel 400 is a “piston” flow.

Advantageously, the hybrid furnace 10 according to the invention is capable of delivering a high-quality glass having less than 0.1 bubbles per liter, preferably less than 0.05 bubbles per liter, such a high-quality glass suitable most particularly for supplying a float glass unit on a molten metal bath.

Advantageously, the hybrid furnace 10 is capable of supplying a float glass unit on a molten metal bath with a pull rate greater than or equal to 400 tons per day, preferably between 600 and 900 tons per day, or even 1000 tons per day or more, with a high-quality glass having less than 0.1 bubble per liter.

Advantageously, a hybrid furnace 10 according to the invention is able to deliver a pull rate analogous to that of a flame furnace, with or without an electrical booster, by virtue of which a float unit is capable of being supplied with high-quality glass.

The hybrid furnace 10 for manufacturing glass according to the invention feeds, via the flow channel 400, a float glass unit on a bath of molten metal, for example tin, intended for the manufacture of flat glass.

Advantageously, the method for manufacturing glass in a hybrid furnace 10 of the type of that which has just been described with reference to FIGS. 1 and 2 comprises successively the steps of:
(a)—melting a vitrifiable mixture in a cold-top electric melting zone to obtain molten glass;
(b)—collecting the molten glass that flows through a first tank neck provided with a separation device from the melting zone to the refining and homogenizing zone;
(c)—refining and homogenizing said molten glass in a refining and homogenizing zone with a hot-top comprising a first convection loop (called the upstream recirculation loop) and a second convection loop (called the downstream recirculation loop);
(d)—cooling the glass in a cooling zone that, formed by a conditioning tank, is passed through by the second convection loop.

Advantageously, the temperature of the molten glass collected in the melting zone 100 is lowered during the passage through the first tank neck 160 comprising the separation device 170 formed by the dam 172 and/or the elevation 161 of the floor 165.

Advantageously and according to the embodiments, the method comprises an adjustment step (e) consisting of adjusting the depth of the movable dam 172 which, immersed in the glass, is arranged in a first tank neck 160 connecting the electric melting zone 100 to the refining and homogenizing zone 200, to control the flow rate of molten glass collected in the melting zone 100.

Advantageously, the adjustment step (e) makes it possible to vary the amount of molten glass passing from the electric melting zone 100 to the refining and homogenizing zone 200, for example as a function of the pull rate.

After the cooling step (d) in the conditioning tank 310, the glass flows into the flow channel 400 intended to supply the float glass unit with high-quality glass.

Advantageously, the method comprises a step of regulating the cooling of the glass in the first tank neck 160, in particular by selectively controlling the means 500 for cooling the glass such as at least one air cooling device 510.

Advantageously, the quantity of cooling air introduced into the first tank neck 160 by the intake means 512 of the air cooling device 510 is controlled in particular as a function of the temperature of the glass.

The following is a description, by comparison with the first embodiment, of a second embodiment of a hybrid furnace 10 shown by FIGS. 3 and 4.

Indeed, the hybrid furnace 10 according to this second embodiment is similar to that described above with reference to FIGS. 1 and 2 so that the description given by it also applies to this second embodiment with the exception of what is detailed below.

One of the differences relative to the first embodiment is that the first tank neck 160 comprises a floor referenced 165, which floor 165 is not flat, said floor 165 not extending in the extension of the flat floor 150 of the electric melting zone 100.

Indeed, and as shown by FIG. 3, the floor 165 of the first tank neck 160 is configured to form at least one elevation 161.

Advantageously, the elevation 161 extends longitudinally over more than half of the length of the first tank neck 160, or even more than three-quarters of said length.

In this second embodiment, the first tank neck 160 of the hybrid furnace 10 advantageously has a length greater than that of the first embodiment, as can also be seen by comparing FIGS. 2 and 4.

Advantageously, the length of the first tank neck 160 is configured to cool the glass intended to flow into the refining and homogenizing zone 200, since the molten glass obtained by electric melting generally has higher temperatures, compared in particular to flame melting.

By way of example, the temperature of the glass in the melting zone is around 1450° C., whereas the desired temperature for the glass in the downstream part of the first tank neck is more in the order of 1300° C. to 1350° C.

According to a feature of the second embodiment, said at least one elevation 161 of the floor 165 of the first tank neck 160 forms part of said separation device 170 ensuring the function of preventing the glass from returning to the melting zone 100.

Advantageously, the separation device 170 according to this second embodiment comprises respectively a dam 172 which, similar to that of the first embodiment, is associated with said at least one elevation 161 of the floor 165 of the first tank neck 160.

However, the dam 172 is not positioned upstream of the first tank neck 160 but inside the first tank neck 160 comprising said at least one elevation 161 of the floor 165, longitudinally between its upstream and downstream ends.

Preferably, the separation device 170 here comprises a single elevation 161 of the floor 165.

By comparison with a barrier (or weir wall), said elevation 161 is directly formed by the floor 165 and not attached thereto so that the elevation 161 consists of the refractory material of the substructure forming said floor 165 of the first tank neck 160. In addition, a barrier is a narrow structure, of small thickness, which is subjected to significant wear that does not lastingly ensure that the glass will not return to the melting zone.

As indicated above, said elevation 161 is wide in that it extends longitudinally over the major part of the length of the first tank neck 160, said elevation 161 advantageously participating in the cooling of the glass in the first tank neck 160.

An exemplary embodiment will be described more particularly hereinafter of the elevation 161 of the floor 165 as shown by FIG. 3.

In FIG. 3, the elevation 161 comprises, successively from upstream to downstream, at least one first ascending section 164, a second top section 166 and a third descending section 168.

Advantageously, the elevation 161 extends transversely over the entire width of the first tank neck 160.

Of course, such an elevation 161 may have numerous geometric variants as regards its general shape, its dimensions, in particular according to the configuration of each of the different sections 164, 166 and 168 constituting it.

Preferably, the ascending section 164 is inclined by an angle (α) determined so as to form a ramp able to cause the molten glass to rise towards the top section 166 of the elevation 161 as shown by FIG. 3.

Preferably, the ascending section 164 is an inclined plane, for example having an acute angle (α) comprised between 20° and 70°, said angle (α) being denoted (see FIG. 6 for greater readability) as the angle between the ascending section 164 of the elevation 161 and the horizontal, here taking as reference the flat floor 150 of the melting zone 100.

As a variant (not shown), the ascending section 164 is stepped, for example, in staircase fashion with at least one step, or even two or more steps whose height and/or length dimensions may or may not be identical.

Preferably, the top section 166 is planar, forming a horizontal plateau. Advantageously, the top section 166 thus extends longitudinally over a given length, preferably here greater than or equal to half the total length of the first tank neck 160.

The top section 166 determines a maximum height H1 that the elevation 161 has and this also determines, in part only due to the dam 172, the section 180 of the passage of the molten glass in the first tank neck 160.

Preferably, the descending section 168 of the elevation 161 extends vertically, connected by a right angle to the downstream end of the flat top section 166 that extends horizontally.

According to another embodiment, for example shown in FIG. 6, which will be described later, the descending section 168 is configured to gradually accompany the flow of the molten glass from the first tank neck 160 to the refining and homogenizing zone 200.

Such a section 168 is for example formed by an inclined plane, which may or may not be stepped, in particular made in steps like the description given above for the alternative embodiments of the ascending section 164.

Besides said at least one elevation 161 that has just been described, the separation device 170 also comprises, in this second embodiment, at least one dam 172 as in the first embodiment, said dam 172 being partially immersed in the molten glass.

The dam 172 and the elevation 161 forming in combination the separation device 170 are able to prevent the molten glass from returning from the refining and homogenizing zone 200 to the electric melting zone 100, that is to say a return from the first convection loop 210 of the glass.

Advantageously, the dam 172 combined with said at least one elevation 161 makes it possible to jointly increase the residence time of the glass in the electric melting zone 100, which helps obtain a high-quality glass.

Advantageously, the dam 172 is capable of having the same features as those described above for the first embodiment.

Preferably, the dam 172 is removable, that is to say dismountable, so that said dam 172 is able to be changed, or repaired, in particular due to the wear occurring in contact with the glass, thus facilitating the maintenance of the hybrid furnace 10.

Likewise, the dam 172 is for example made of non-refractory metal or alloy, said dam 172 then being able to be cooled by a cooling fluid cooling circuit (not shown), in particular a circuit of the water jacket type.

Alternatively, the dam 172 is made of refractory material, typically ceramic, for example an electrofused refractory “AZS” (acronym for Alumina-Zircon-Silica) or a refractory metal such as molybdenum.

As shown in FIG. 3, said at least one dam 172 is arranged longitudinally between the downstream and upstream ends of the first tank neck 160.

Preferably, the dam 172 is positioned vertically above the top section 166 of the elevation 161.

Preferably, the dam 172 extends transversely over the entire width of the first tank neck 160 as shown by FIG. 4.

Advantageously, the dam 172 is mounted to move vertically to make it possible to adjust the submersion depth in the glass bath 130 so that the section 180 of the passage of the molten glass located above the top section 166 of the elevation 161, is capable of varying as a function of the adjustment of the depth of the dam 172 relative to the depth P1 of the glass determined by the height H1.

Advantageously, the hybrid furnace 10 further comprises at least one separation means 174, such as a partition, to separate the atmosphere from the electric melting zone 100 and the atmosphere of the refining and homogenizing zone 200 comprising in particular flue gases.

As shown in FIGS. 3 and 4, the separation means 174 is arranged at the upstream end of the first tank neck 160, adjacent to the electric melting zone 100.

In this second embodiment, the separation means 174, formed here by a partition, is in contact with the surface of the glass, or even immersed at its free end, to establish not only said atmospheric separation but also to retain the vitrifiable mixture layer 112 in the electric melting zone 100.

Advantageously, the separation means 174 thus provides another function, namely that of blocking means 176 so that the layer 112 of vitrifiable mixture present on the surface of the glass bath 130 does not penetrate into the first tank neck 160.

In this second embodiment, the blocking means 176 are therefore formed by the free end of the separation means 174 consisting of the partition which extends for this purpose at the bath surface 130, or even preferentially is immersed in the glass bath 130.

Alternatively, the means 176 for blocking the layer 112 are structurally distinct from the separation means 174, said blocking means 176 then being able to be adjacent or remote from said separation means 174.

Such a variant is also shown by FIG. 5 or 6 representing a third embodiment which will be described in more detail later.

The separation means 174 is for example located downstream of the blocking means 176, that is to say at a distance therefrom. Alternatively, the separation means 174 is attached to said blocking means 176.

Compared to the first embodiment, the delimitation of the vitrifiable mixture layer 112 is therefore not ensured here by the dam 172 but rather either by the free end of the separation means 174 in this second embodiment shown by FIGS. 3 and 4, or by separate blocking means 176 in the third embodiment shown in FIG. 5 or 6.

A third embodiment which is shown by FIG. 5 (and FIG. 6 showing an alternative embodiment of the elevation) will be described below, in comparison with the second embodiment most particularly.

In this third embodiment, the so-called “non-return” separation device 170 is only constituted by at least one elevation 161 of the floor 165 of the first tank neck 160, as compared to the second embodiment shown in FIGS. 3 and 4, or even with the first embodiment, so that there is therefore no movable dam 172.

Preferably, the hybrid furnace 10 comprises an elevation 161 of the floor 165 which has a height H2, denoted in FIG. 5 relative to the horizontal at the flat floor 150 of the melting zone 100 taken as reference, said height H2 being comparatively greater than the height H1 denoted in FIG. 3.

Advantageously, the elevation 161 of the floor 165 of the first tank neck 160 is of identical shape to that described above with reference to FIG. 3, namely consisting successively of an ascending section 164, a top section 166 and a descending section 168.

As shown in FIG. 5, the depth P2 between the surface S of molten glass and the top section 166 of the elevation 161 of the floor 165 is less than the depth P1.

In this third embodiment, the passage section 180 of the molten glass is thus not determined by the dam 172 advantageously mounted movably but is only determined by said elevation 161 of the floor 165 so that said passage section 180 is in particular not able to be modified.

In the absence of a dam 172, the hybrid furnace 10 nevertheless comprises at least one separation means 174 as in the first embodiment and the second embodiment, which is able to separate the respective atmospheres from the electric melting zone 100 and from the refining and homogenizing zone 200.

Moreover and as described above as a variant for the second embodiment, the blocking means 176 are preferably distinct and separate from said separation means 174.

Alternatively and as in the second embodiment, the blocking means 176 are formed by a separation means 174 whose free end, that is to say here the lower end, is preferably immersed in the glass bath 130.

According to one alternative embodiment of the elevation 161 of the floor 165 of the first tank neck 160 shown in FIG. 6, the descending section 168 is configured to gradually accompany the flow of the molten glass toward the refining and homogenizing zone 200.

Such a section 168 is for example formed by an inclined plane, which may or may not be stepped, in particular in a staircase shape.

Preferably, the section 168 is inclined by an angle (β) determined so as to form a ramp able to cause gradual descent of the molten glass toward the floor 250 of the refining and homogenizing zone 200.

For the descending section 168, the angle (β) is an obtuse angle which may for example have a value of between 90° and 145°, said angle (β) corresponding to the internal angle noted at the junction of the top section 166 and the descending section 168 in FIG. 6.

As a variant (not shown), the ascending section 168 is not flat but is stepped, for example, in staircase fashion with at least one step, or even two or more steps whose height and/or length dimensions may or may not be identical.

As shown by the Figures, the depth of glass is here not identical longitudinally on either side of said at least elevation 161, respectively between the flat floor 150 of the electric melting zone 100 and the start of the floor 250 of the refining and homogenizing zone 200, downstream of the first tank neck 160, which refining and homogenizing zone 200 is likely to have at least one variation in depth.

As previously indicated, such an elevation 161 may have numerous geometric variants as regards its general shape, its dimensions, in particular according to the configuration of each of the different sections 164, 166 and 168 constituting it.

1. A hybrid glass manufacturing furnace for manufacturing glass for supplying a unit for floating the glass on a molten metal bath, said hybrid furnace comprising, from upstream to downstream:
an electric melting zone with a cold-top comprising electrodes for melting a vitrifiable mixture in order to obtain a bath of glass;
a refining and homogenizing zone with a hot-top, comprising a first convection loop and a second convection loop; and
a zone for cooling the glass formed by a conditioning tank which, being passed through by said second convection loop, is connected to at least one flow channel,
wherein the hybrid glass manufacturing furnace comprises at least one tank neck which, forming a first tank neck, comprises a floor and connects the electric melting zone to the refining and homogenizing zone of the glass and wherein said hybrid glass manufacturing furnace comprises a non-return separation device which, positioned at said first tank neck, is configured to prevent the molten glass in the refining and homogenizing zone from returning to the melting zone.

2. The hybrid glass manufacturing furnace according to claim 1, wherein the non-return separation device comprises a dam configured to be partially immersed in the glass bath.

3. The hybrid glass manufacturing furnace according to claim 1, wherein the separation device comprises at least one elevation of the floor of the first tank neck.

4. The hybrid glass manufacturing furnace according to claim 3, wherein said at least one elevation of the floor comprises, from upstream to downstream, at least one ascending section, a top section and a descending section.

5. The hybrid glass manufacturing furnace according to claim 4, wherein the non-return separation device comprises a dam configured to be partially immersed in the glass bath and wherein the dam is arranged in the first tank neck above the top section of the elevation of the floor.

6. The hybrid glass manufacturing furnace according to claim 4, wherein at least one of said ascending section and descending section of said at least one elevation of the floor is inclined relative to the horizontal and/or comprises a top section.

7. The hybrid glass manufacturing furnace according to claim 3, wherein said at least one elevation has a maximum height that determines, in whole or in part, a section of passage of the molten glass in the first tank neck.

8. The hybrid glass manufacturing furnace according to claim 2, wherein the dam is movably mounted vertically to allow adjustment of the immersion depth in the glass bath.

9. The hybrid glass manufacturing furnace according to claim 2, wherein the dam is removable in order to allow it the dam to be replaced in the event of wear and to facilitate the maintenance of the furnace.

10. The hybrid glass manufacturing furnace according to claim 1, further comprising at least one atmospheric separation means, which is able to separate atmosphere from the electric melting zone with a cold-top and atmosphere of the homogenization and homogenizing zone with a hot-top.

11. The hybrid glass manufacturing furnace according to claim 1, further comprising blocking means which, arranged at the upstream end of the first tank neck, are able to retain the layer of vitrifiable mixture in the electric melting zone so that said vitrifiable mixture present on the surface of the glass bath does not penetrate into the first tank neck.

12. The hybrid glass manufacturing furnace according to claim 11, wherein the non-return separation device comprises a dam configured to be partially immersed in the glass bath and wherein the means for blocking the vitrifiable mixture layer are formed by the dam.

13. The hybrid glass manufacturing furnace according to claim 11, further comprising at least one atmospheric separation means, which is able to separate atmosphere from the electric melting zone with a cold-top and atmosphere of the homogenization and homogenizing zone with a hot-top, and wherein the blocking means are formed by the at least one atmospheric separation means whose free end extends at the surface of the bath, or is immersed in the glass bath.

14. The hybrid glass manufacturing furnace according to claim 11, further comprising at least one atmospheric separation means, which is able to separate atmosphere from the electric melting zone with a cold-top and atmosphere of the homogenization and homogenizing zone with a hot-top and wherein the blocking means are separate from said at least one atmospheric separation means, said blocking means being attached to or remote from the at least one atmospheric separation means.

15. The hybrid glass manufacturing furnace according to claim 1, further comprising means for cooling the glass which are able to cool the glass in the first tank neck.

16. The hybrid glass manufacturing furnace according to claim 1, wherein the electrodes are arranged on the surface so as to be immersed into the vitrifiable mixture.

17. The hybrid glass manufacturing furnace according to claim 1, wherein the electrodes are arranged through a floor of the melting zone so as to be immersed in the vitrifiable mixture.

18. The hybrid glass manufacturing furnace according to claim 16, wherein the electric melting zone comprises a low-convection zone, forming a buffer zone, located between a free end of the electrodes and a floor of the melting zone.

19. The hybrid glass manufacturing furnace according to claim 18, wherein the melting zone is configured to have a depth determined so as to obtain said low-convection buffer zone.

20. The hybrid glass manufacturing furnace according to claim 1, wherein the first convection loop and the second convection loop are separated by a loop inversion zone of the loops determined by a hot spot or source corresponding to the hottest point of the glass and wherein the refining and homogenizing zone comprises at least one burner which is arranged to obtain said hot spot determining said loop inversion zone.

21. The hybrid glass manufacturing furnace according to claim 20, wherein the hybrid furnace comprises a barrier which is arranged in said loop inversion zone.

22. The hybrid glass manufacturing furnace according to claim 1, wherein the hybrid glass manufacturing furnace comprises modulation means which, arranged in the refining and homogenizing zone, are capable of modulating the convection of said loops in order to facilitate the glassmaking process.

23. The hybrid glass manufacturing furnace according to claim 1, wherein the conditioning tank of the cooling zone comprises, from upstream to downstream, a second tank neck then a working end.

24. The hybrid glass manufacturing furnace according to claim 1, wherein the hybrid furnace is configured to supply glass to said float glass unit with a pull rate greater than or equal to 400 tons per day, said glass having less than 0.1 bubbles per liter.

25. An assembly for the manufacture of flat glass comprising a hybrid furnace for manufacturing glass according to claim 1 and a float glass unit on a molten metal bath which, arranged downstream, is supplied with glass by said furnace via said at least one flow channel.

26. The hybrid glass manufacturing furnace according to claim 15, wherein the means for cooling the glass comprises least one air-circulation cooling device.
